(19) United States
(12) Patent Application Publication
(10) Pub. No.: US 2003/0154084 A1
(43) Pub. Date: Aug. 14, 2003

(54) Method and system for person identification using video-speech matching

(75) Inventors: Mingkun Li, Rochester, NY (US); Dongge Li, Ossining, NY (US); Nevenka Dimitrova, Yorktown Heights, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/076,194

(22) Filed: Feb. 14, 2002

(51) Int. Cl. G10L 21/00; G10L 11/00

(52) U.S. Cl. 704/273

(57) ABSTRACT

A method and system are disclosed for determining who is the speaking person in video data. This may be used to add in person identification in video content analysis and retrieval applications. A correlation is used to improve the person recognition rate relying on both face recognition and speaker identification. Latent Semantic Association (LSA) process may also be used to improve the association of a speaker's face with his voice. Other sources of data (e.g., text) may be integrated for a broader domain of video content understanding applications.

### FIELD OF THE INVENTION

The present invention relates to the field of object identification in video data. More particularly, the invention relates to a method and system for identifying a speaking person within video data.

### BACKGROUND OF THE INVENTION

Person identification plays an important role in our everyday life. We know how to identify a person from a very young age. With the extensive use of video cameras, there is an increased need for automatic person identification from video data. For example, almost every department store in the US has a surveillance camera system. There is a need to identify, e.g., criminals or other persons from a large video set. However manually searching the video set is a time-consuming and expensive process. A means for automatic person identification in large video archives is need for such purposes.

Conventional systems for person identification have concentrated on single modality processing, for example, face detection and recognition, speaker identification, and name spotting. In particular, typical video data contains a great deal of information through three complementary sources, image, audio and text. There are techniques to perform person identification in each source, for example, face detection and recognition in the image domain, speaker identification in the audio domain and name spotting in the text domain. Each one has its own applications and drawbacks. For example, name spotting cannot work in the video without good text sources, such as closed captions or teletext in a television signal.

Some conventional systems have attempted to integrate multiple cues from video, for example, J. Yang, et. Al., Multimodal People ID For A Multimedia Meeting Browser, Proceedings of ACM Multimedia '99, ACM, 1999. This system uses face detection/recognition and speaker identification techniques using a probability framework. This system, however, assumes that the person appearing on the video is the person speaking, which is not always true.

Thus, there exists a need in the art for a person identification system that is able to find who is speaking in a video and build a relationship between the speech/audio and multiple faces in the video from low-level features.

### SUMMARY OF THE INVENTION

The present invention embodies a face-speech matching approach that can use low-level audio and visual features to associate faces with speech. This may be done without the need for complex face recognition and speaker identification techniques. Various embodiments of the invention can be used for analysis of general video data without prior knowledge of the identities of persons within a video.

The present invention has numerous applications such as speaker detection in video conferencing, video indexing, and improving the human computer interface. In video conferencing, knowing who is speaking can be used to cue a video camera to zoom in on that person. The invention can also be used in bandwidth-limited video conferencing applications so that only the speaker's video is transmitted. The present invention can also be used to index video (e.g., “locate all video segments in which a person is speaking”), and can be combined with face recognition techniques (e.g., “locate all video segments of a particular person speaking”). The invention can also be used to improve human computer interaction by providing software applications with knowledge of where and when a user is speaking.

As discussed above, person identification plays an important role in video content analysis and retrieval applications. Face recognition in visual domain and speaker identification in audio domain are the two main techniques to find person in the video. One aspect of the present invention is to improve the person recognition rate relying on both face recognition and speaker identification applications. In one embodiment, a mathematical framework, Latent Semantic Association (LSA), is used to associate a speaker's face with his voice. This mathematical framework incorporates correlation and latent semantic indexing methods. The mathematical framework can be extended to integrate more sources (e.g., text information sources) and be used in a broader domain of video content understanding applications.

One embodiment of the present invention is directed to an audio-visual system for processing video data. The system includes an object detection module capable of providing a plurality of object features from the video data and an audio segmentation module capable of providing a plurality of audio features from the video data. A processor is coupled to the face detection and the audio segmentation modules. The processor determines a correlation between the plurality of face features and the plurality of audio features. This correlation may be used to determine whether a face in the video is speaking.

Another embodiment of the present invention is directed to a method for identifying a speaking person within video data. The method includes the steps of receiving video data including image and audio information, determining a plurality of face image features from one or more faces in the video data and determining a plurality of audio features related to audio information. The method also includes the steps of calculating a correlation between the plurality of face image features and the audio features and determining the speaking person based upon the correlation.

Yet another embodiment of the invention is directed to a memory medium including software code for processing a video including images and audio. The code includes code to obtain a plurality of object features from the video and code to obtain a plurality of audio features from the video. The code also includes code to determine a correlation between the plurality of object features and the plurality of audio features and code to determine an association between one or more objects in the video and the audio.

In other embodiments, a latent semantic indexing process may also be performed to improve the correlation procedure.

Still further features and aspects of the present invention and various advantages thereof will be more apparent from the accompanying drawings and the following detailed description of the preferred embodiments.

### BRIEF DESCRIPTION OF THE DRAWINGS

FIG. 1 shows a person identification system in accordance with one embodiment of the present invention.

FIG. 2 shows a conceptual diagram of a system in which various embodiments of the present invention can be implemented.

FIG. 3 is a block diagram showing the architecture of the system of FIG. 2.

FIG. 4 shows a flowchart describing a person identification method in accordance with another embodiment of the invention.

FIG. 5 shows an example of a graphical depiction of a correlation matrix between face and audio features.

FIG. 6 shows an example of graphs showing the relationship between average energy and a first eigenface.

FIG. 7 shows an example of a graphical depiction of the correlation matrix after applying an LSI procedure.

### DETAILED DESCRIPTION OF THE INVENTION

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for purposes of simplicity and clarity, detailed descriptions of well-known devices, circuits, and methods are omitted so as not to obscure the description of the present invention with unnecessary detail.

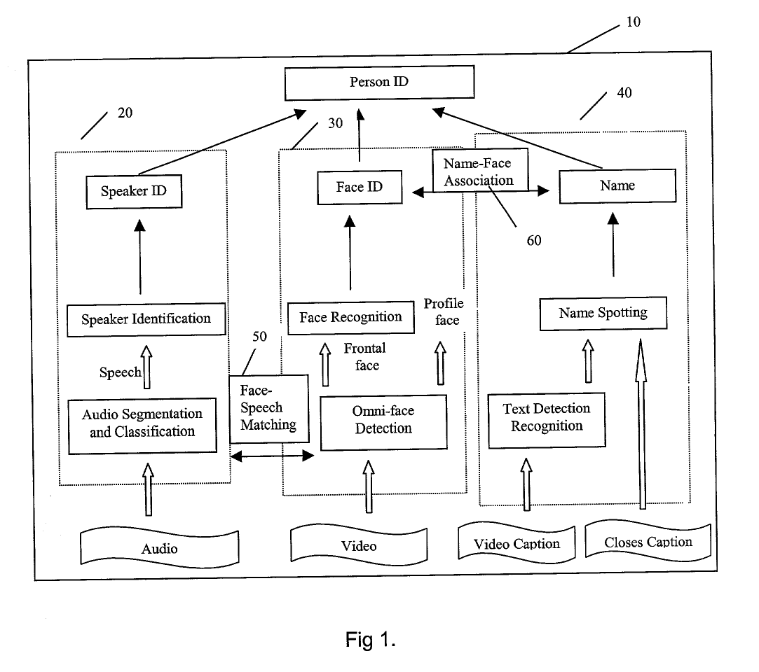

Referring to FIG. 1, a person identification system 10 includes three independent and mutually interactive modules, namely, speaker identification 20, face recognition 30 and name spotting 40. It is noted, however, that the modules need not be independent, e.g., some may be integrated. But preferably, each module is independent and can interact with each other in order to obtain better performance from face-speech matching and name-face association.

There are several well-known techniques to independently perform face detection and recognition, speaker identification and name spotting. For example, see S. Satoh, et. Al., Name-It: Naming and detecting faces in news videos, IEEE Multimedia, 6(1): 22-35, January-March (Spring) 1999 for a system to perform name-face association in TV news. But this system also assumes that the face appearing in the video is the person speaking, which is not always true.

The inputs into each module, e.g., audio, video, video caption (also called videotext) and closed caption, can be from a variety of sources. The inputs may be from a videoconference system, a digital TV signal, the Internet, a DVD or any other video source.

When a person is speaking, he or she is typically making some facial and/or head movements. For example, the head may be moving back and forth, or the head may be turning to the right and left. The speaker's mouth is also opening and closing. In some instances the person may be making facial expressions as well as giving some-type of gestures.

An initial result of head movement is that the position of a face image is changed. In a videoconference case, normally the movement of a camera is different than speaker's head movement, i.e., not synchronized. The effect is the change of direction of face to camera. Thus the face subimage will change its size, intensity and color slightly. In this regard, movement of the head results in position and image changes of face.

To capture mouth movement, two primary approaches may be used. First the movement of the mouth can be tracked. Conventional systems are known in speech recognition regarding lip reading. Such systems track the movement of lips to guess what word is pronounced. However, due to complexity of video domain, it is a complicated task to track the lips' movement.

Alternatively, face changes resulting from lip movement can be tracked. With the lip movement, the color intensity of lower face image will change. In addition, face image size will also change slightly. Through tracking changes in the lower part of a face image, lip movement can be tracked. Because only knowledge regarding whether the lips have moved or not is needed, there is no requirement to exactly know how the lips have moved.

Similar to lip movement, facial expressions will change a face image. Such changes can be tracked in a similar manner.

Considering these three actions resulting from speech (i.e., head movement, lip movement and facial expression) the most important is the lips' movement. As should be clear, lip movement is directly related to speech. Thus by tracking lip movement precisely, a determination of the speaking person can be performed. For this reason, tracking the position of head and lower image of face, which reflects the movement of head and lips, is preferred.

The above discussion has focused on video changes in the temporal domain. In the spatial domain, several useful observations can be made to assist in tracking image changes. First the speaker often appears in the center of the video image. Second, the size of speaker's face normally takes up a relative large portion of the total image displayed (e.g., twenty-five percent of the image or more). Third, the speaker's face is usually frontal. These observations may be used to aid in tracking image changes. But it is noted that these observations are not required to track image changes.

In pattern recognition systems, feature selection is a crucial part. To aid in selecting appropriate features to track, the discussion and analysis discussed above may be used. A learning process can also then be used to perform feature optimization and reduction.

For the face image (video input), a PCA (principal component analysis) representation may be used. (See Francis Kubala, et al., Integrated Technologies For Indexing Spoken language, Communication of ACM, February 2000/Vol. 43, No. 2). A PCA representation can be used to reduce the number of features dramatically. It is well known, however, that PCA is very sensitive to face direction, which is a disaster for face recognition. However, contrary to conventional wisdom, this is exactly what is preferred because this will allow for the tracking of changes of the direction of face.

Alternatively, a LFA (local feature analysis) representation may be used for the face image. LFA is an extension of PCA. LFA uses local features to represent one face. (See Howard D. Wactlar, et al., Complementary Video and Audio Analysis For Broadcast News Archives, Communication of ACM, February 2000/Vol. 43, No. 2). Using LFA, different movements of a face, for example, lip movement can be tracked.

For the audio data input, up to twenty (20) audio features may be used. These audio features are:

average energy;

pitch;

zero crossing;

bandwidth;

band central;

roll off;

low ratio;

spectral flux; and

12 MFCC components.

(See Dongge Li, et al., Classification Of General Audio Data For Content-Based Retrieval, Pattern Recognition Letters, 22, (2001) 533-544). All or a subset of these audio features may be used for speaker identification.

In mathematical notation, the audio features may be represented by:

A=(a₁,a₂, . . . ,a_{K})′ [1]

K represents the number of audio features used to represent a speech signal. Thus, for example, each video frame, a K dimensional vector is used to represent speech in a particular video frame. The symbol ′ represents matrix transposition.

In the case of the image data (e.g., video input), for each face, I features are used to represent it. So for each video frame, an I dimension face vector is used for each face. Assuming that there are M faces in the video data, the faces for each video frame can be represented as follows:

F=(f₁¹,f₂¹, . . . ,f_{I}¹, f₁², . . . ,f_{I}², . . . ,f_{I}^{M})′ [2]

Combining all the components of the face features and the audio features, the resulting vector will be:

V=(f₁¹,f₂¹, . . . ,f_{I}¹,f₁², . . . ,f_{I}², . . . ,f_{I}^{M},a₁, . . . ,a_{K})′ [3]

V represents all the information about the speech and face in one video frame. When considered in a larger context, if there are N frames in one trajectory, the V vector for ith frame is Vᵢ.

Referring to FIG. 1, a face-speech matching unit 50 is shown. The face-speech matching unit 50 uses data from both the speaker identification 20 and the face recognition 30 module. As discussed above, this data includes the audio features and the image features. The face-speech matching unit 50 then determines who is speaking in a video and builds a relationship between the speech/audio and multiple faces in the video from low-level features.

In a first embodiment of the invention, a correlation method may be used to perform the face-speech matching. A normalized correlation is computed between audio and each of a plurality of candidate faces. The candidate face which has maximum correlation with audio is the face speaking. It should be understood that a relationship between the face and the speech is needed to determine the speaking face. The correlation process, which computes the relation between two variables, is appropriate for this task.

To perform the correlation process, a calculation to determine the correlation between the audio vector [1] and face vector [2] is performed. The face that has maximum correlation with audio is selected as the speaking face. This takes into consideration that the face changes in the video data correspond to speech in the video. There are some inherent relationships between the speech and speaking person: the correlation, which is the representation of the relation in mathematics, provides a gauge to measure these relationships. The correlation process to calculate the correlation between the audio and face vectors can be mathematically represented as follows:

The mean vector of the video is given by:

$${V}_{m} = \frac{1}{N} {\sum }_{i = 1}^{N} Vi \qquad [ 4 ]$$

A covariance matrix of V is given by:

$$\hat{C} = \frac{1}{N} {\sum }_{i = 1}^{N} ( {V}_{i} - {V}_{m} ) {( {V}_{i} - {V}_{m} )}^{′} \qquad [ 5 ]$$

A normalized covariance is given by:

$$C ( i , j ) = \frac{\hat{C} ( i , j )}{\sqrt{\hat{C} ( i , i ) \hat{C} ( i j , j )}} \qquad [ 6 ]$$

The correlation matrix between A, the audio vector [1] and the m-th face in the face vector [2] is the submatrix C(IM+1:IM+K, (m−1)I+1:mI). The sum of all the elements of this submatrix, denoted as c(m), is computed, which is the correlation between the m-th face vector and m-th face vector. The face that has the maximum c(m) is chosen as the speaking face as follows:

$$F ( speaking ) = arg {max}_{i} c ( i ) \qquad [ 7 ]$$

In a second embodiment, an LSI (Latent Semantic Indexing) method may also be used to perform the face-speech matching. LSI is a powerful method in text information retrieval. LSI uncovers the inherent and semantic relationship between objects there, namely, keywords and documents. LSI uses singular value decomposition (SVD) in matrix computations to get new representation for keywords and documents. In this new representation, the basis for keywords and documents are uncorrelated. This allows for the use of a much smaller set of basis vectors to represent keywords and documents. As a result, three benefits are secured. The first is dimension reduction. The second is noise removal. The third is to discover the semantic and hidden relation between different objects, like keywords and documents.

In this embodiment of the present invention, LSI can be used to find the inherent relationship between audio and faces. LSI can remove the noise and reduce features in some sense, which is particularly useful since typical image and audio data contain redundant information and noise.

In the video domain, however, things can be much more subtle than in the text domain. This is because in the text domain, the basic composition block of documents, keywords, is meaningful on their own. In the video domain, the low-level representation of image and audio may be meaningless on their own. However, their combination together represents something more than the individual components. With this premise, there must be some relationship between image sequences and accompanying audio sequences. The inventors have found that LSI disposes the relationship in the video domain.

To perform the LSI process, a matrix for the video sequence is built using the vectors discussed above:

\hat{X}=(V₁,V₂, . . . ,V_{N}) [8]

As discussed above, each component of V is heterogeneous consisting of the visual and audio features: V=(f₁¹, f₂¹, . . . , f_{I}¹, f₁², . . . , f_{I}², . . . , f_{I}^{M}, a₁, . . . , a^{K})′. Simply putting them together and performing SVD directly might not make sense. Therefore, each component is normalized by their maximum elements as:

$$X ( i , \text{:} ) = \frac{\hat{X} ( i , \text{:} )}{max ( abs ( \hat{X} ( i , \text{:} ) ) )} \qquad [ 9 ]$$

In equation [9], X(i, :) denotes the i-th row of matrix X. The denominator is the maximum absolute element of the i-th row. The resulting matrix X has elements between −1 and 1. If the dimension of V is H, then X is a HxN dimension matrix. A singular value decomposition is then performed on X as follows:

X=SVD′ [10]

S is composed of the eigenvectors of XX′ column-by-column, D consists of the eigenvectors of X′X, V² is a diagonal matrix where diagonal elements are eigenvalues.

Normally, the matrices of S, V, D must all be of full rank. The SVD process, however, allows for a simple strategy for optimal approximate fit using smaller matrices. The eigenvalues are ordered in V in descending order. The first k elements are kept so that X can be represented by:

X≅\hat{X}=\hat{SVD}′ [11]

\hat{V} consists the first k elements of V, Ŝ consists the first k columns of S and \hat{D} consists the first k columns of D. It can be shown that \hat{X} is the optimal representation of X in least square sense.

After having the new representation of X, various operations can be performed in the new space. For example, the correlation of the face vector [2] and the audio vector [1] can be computed. The distance between face vector [2] and the audio vector [1] can be computed. The difference between video frames to perform frame clustering can also be computed. For face-speech matching, the correlation between face features and audio features is computed as described above in the correlation process.

There is some flexibility in the choice of k. This value should be chosen so that it is large enough to keep the main information of the underlying data, and at the same time small enough to remove noise and unrelated information. Generally k should be in the range of 10 to 20 to give good system performance.

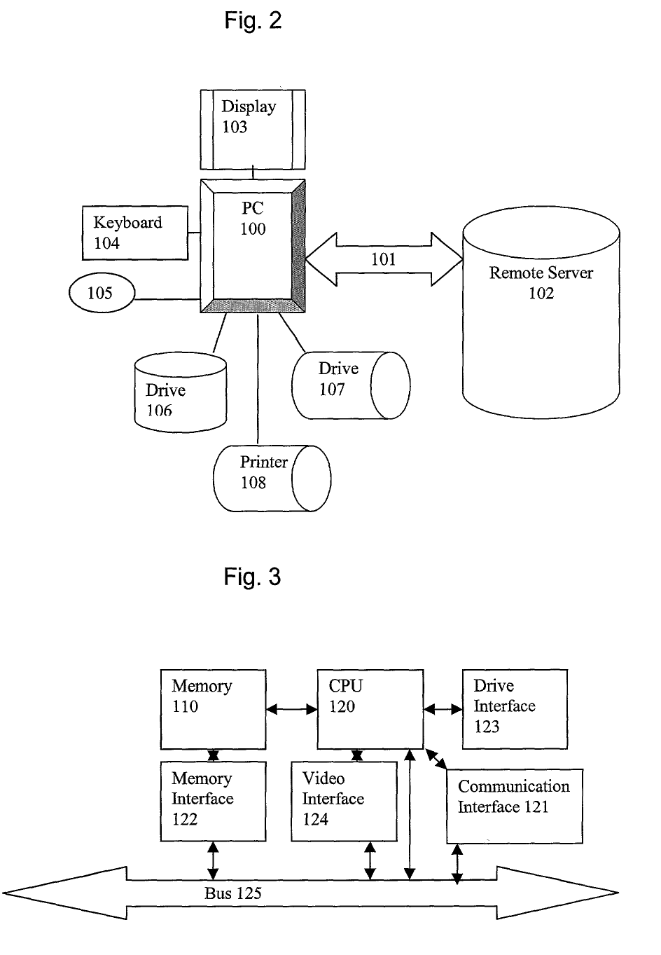

FIG. 2 shows a conceptual diagram describing exemplary physical structures in which various embodiments of the invention can be implemented. This illustration describes the realization of a method using elements contained in a personal computer. In a preferred embodiment, the system 10 is implemented by computer readable code executed by a data processing apparatus. The code may be stored in a memory within the data processing apparatus or read/downloaded from a memory medium such as a CD-ROM or floppy disk. In other embodiments, hardware circuitry may be used in place of, or in combination with, software instructions to implement the invention. For example, the invention may implemented on a digital television platform or set-top box using a Trimedia processor for processing and a television monitor for display.

As shown in FIG. 2, a computer 100 includes a network connection 101 for interfacing to a data network, such as a variable-bandwidth network, the Internet, and/or a fax/modem connection for interfacing with other remote sources 102 such as a video or a digital camera (not shown). The computer 100 also includes a display 103 for displaying information (including video data) to a user, a keyboard 104 for inputting text and user commands, a mouse 105 for positioning a cursor on the display 103 and for inputting user commands, a disk drive 106 for reading from and writing to floppy disks installed therein, and a CD-ROM/DVD drive 107 for accessing information stored on a CD-ROM or DVD. The computer 100 may also have one or more peripheral devices attached thereto, such as a pair of video conference cameras for inputting images, or the like, and a printer 108 for outputting images, text, or the like.

Other embodiments may be implemented by a variety of means in both hardware and software, and by a wide variety of controllers and processors. For example, it is noted that a laptop or palmtop computer, video conferencing system, a personal digital assistant (PDA), a telephone with a display, television, set-top box or any other type of similar device may also be used.

FIG. 3 shows the internal structure of the computer 100 that includes a memory 110 that may include a Random Access Memory (RAM), Read-Only Memory (ROM) and a computer-readable medium such as a hard disk. The items stored in the memory 110 include an operating system, various data and applications. The applications stored in memory 110 may include a video coder, a video decoder and a frame grabber. The video coder encodes video data in a conventional manner, and the video decoder decodes video data that has been coded in the conventional manner. The frame grabber allows single frames from a video signal stream to be captured and processed.

Also included in the computer 100 are a central processing unit (CPU) 120, a communication interface 121, a memory interface 122, a CD-ROM/DVD drive interface 123, a video interface 124 and a bus 125. The CPU 120 comprises a microprocessor or the like for executing computer readable code, i.e., applications, such those noted above, out of the memory 110. Such applications may be stored in memory 110 (as noted above) or, alternatively, on a floppy disk in disk drive 106 or a CD-ROM in CD-ROM drive 107. The CPU 120 accesses the applications (or other data) stored on a floppy disk via the memory interface 122 and accesses the applications (or other data) stored on a CD-ROM via CD-ROM drive interface 123.

The CPU 120 may represent, e.g., a microprocessor, a central processing unit, a computer, a circuit card, a digital signal processor or an application-specific integrated circuit (ASICs). The memory 110 may represent, e.g., disk-based optical or magnetic storage units, electronic memories, as well as portions or combinations of these and other memory devices.

Various functional operations associated with the system 10 may be implemented in whole or in part in one or more software programs stored in the memory 110 and executed by the CPU 120. This type of computing and media processing device (as explained in FIG. 3) may be part of an advanced set-top box.

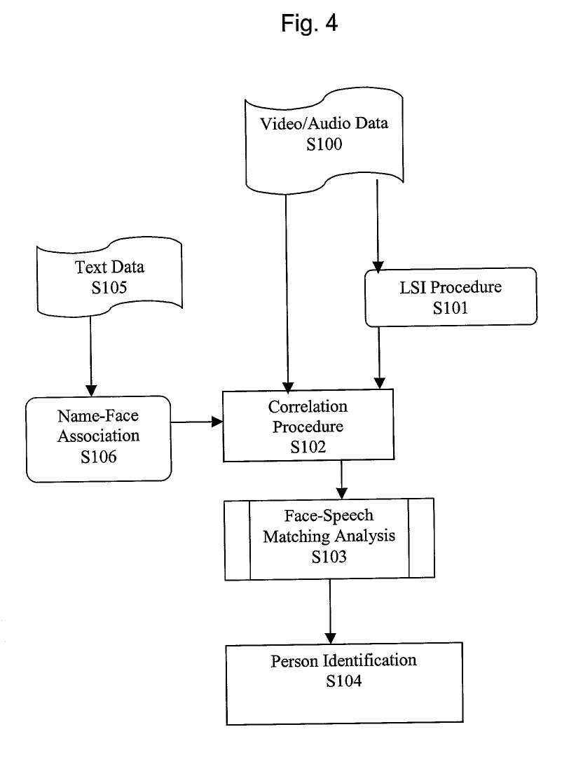

Shown in FIG. 4 is a flowchart directed to a speaker identification method. The steps shown correspond to the structures/procedures described above. In particular, in step S100, video/audio data is obtained. The video/audio data may be subjected to the correlation procedure directly (S102) or first preprocessed using the LSI procedure (S101). Based upon the output of the correlation procedure, the face-speech matching analysis (S103) can be performed. For example, the face with the largest correlation value is chosen as the speaking face. This result may then be used to perform person identification (S104). As described additionally below, the correlation procedure (S102) can also be performed using text data (S105) processed using a name-face association procedure (S106).

To confirm the relationships between video and audio discussed above, the inventors have performed a series of experiments. Two video clips were used for the experiments. For one experiment, a video clip was selected in which two persons appear on the screen while one is speaking. For another experiment a video clip was selected in which one person is speaking without too much motion, one person is speaking with a lot of motion, one person is sitting there without motion while other person is speaking, and one person is sitting there with a lot of motion while the other is speaking. For these experiments a program for manual selection and annotation of the faces in video was implemented.

The experiments consist of three parts. The first one was used to illustrate the relationship between audio and video. Another part was used to test face-speech matching. Eigenfaces were used to represent faces because one purpose of the experiments was person identification. Face recognition using PCA was also performed.

Some prior work has explored the general relationship of audio and video. (See Yao Wang, et al., Multimedia Content Analysis Using Both Audio and Visual Clues, IEEE Signal Processing Magazine, November 2000, pp12-36). This work, however, declares that there is no relationship between audio features with the whole video frame features. This is not accurate because in the prior art systems there was too much noise in both the video and the audio. Thus the relationship between audio and video is hidden by the noise. In contrast, in the embodiments discussed above, only the face image is used to calculate the relationship between audio and video.

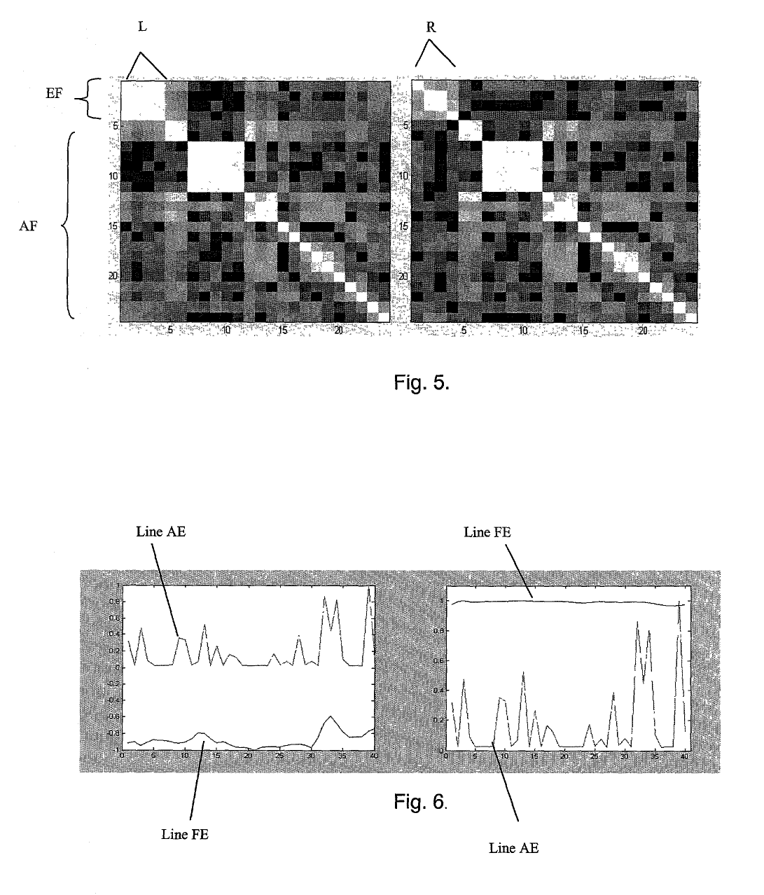

By way of example, a correlation matrix (calculated as discussed above) is shown in FIG. 5. One cell (e.g., square) represents a corresponding element of the correlation matrix. The larger the element numerical is, the whiter the cell is. The left picture represents the correlation matrix for a speaking face, which reflects the relationship between the speaker's face with his voice. The right picture represents the correlation matrix between a silent listener with another person's speech. The first four elements (EF) are correlation values for eigenfaces. The remaining elements are audio features (AF): average energy, pitch, zero crossing, bandwidth, band central, roll off, low ratio, spectral flux and 12 MFCC components, respectively.

From these two matrices, it can be seen that there is a relationship between audio and video. Another observation is that the elements in the four columns under 4^{th} row (L) in the left picture are much brighter than corresponding elements (R) in the right picture, which means that the speaker's face has relation with his voice. Indeed, the sum of these elements is 15.6591 in the left matrix; the sum of these elements in the right matrix is 9.8628.

Another clear observation from FIG. 5 is that the first four columns of the 5^{th} row and 6^{th} row in left picture are much brighter than the corresponding elements in the right picture. The sum of these eight elements is 3.5028 in the left picture, is 0.7227 in the right picture. The 5^{th} row represents the correlation between face and the average energy. The 6^{th} row represents the correlation between face and pitch. It should be understood that when a person is speaking, his face is changing too. More specifically, the voice's energy has a relationship to the speaking person's opening and closing mouth. Pitch has a corresponding relationship.

This is further demonstrated in FIG. 6 in which the first eigenface and average energy with time is shown. The line AE represents the average energy. The line FE represents the first eigenface. The left picture uses the speaker's eigenface. The right uses a non-speakers eigenface. From left picture in FIG. 6, the eigenface has a similar change trend as the average energy. In contrast, the non-speakers face does not change at all.

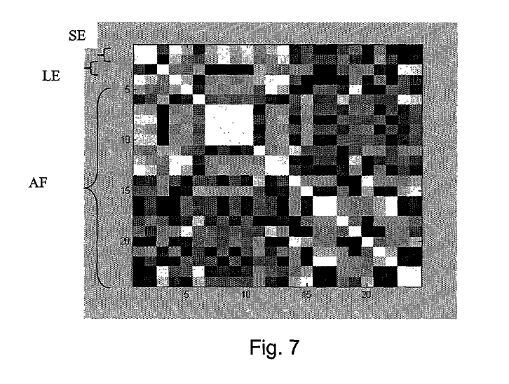

Shown in FIG. 7, is a computed correlation of audio and video features on the new space transformed by LSI. The first two components are the speaker's eigenfaces (SE). The next two components are the listener's eigenfaces (LE). The other components are audio features (AF). From FIG. 7, it can be seen that the first two columns are brighter than the next two columns, which means that speaker's face is correlated with his voice.

In another experiment related to the face-speech matching framework, various video clips were collected. A first set of four video clips contain four different person, and each clip contains at least two people (one speaking and one listening). A second set of fourteen video clips contain seven different persons, and each person has at least two speaking clips. In addition, two artificial listeners were inserted in these video clips for testing purposes. Hence there are 28 face-speech pairs in the second set. In total there are 32 face speech pairs in the video test set collection.

First the correlation between audio features and eigenfaces for each face-speech pair was determined according to the correlation embodiment. The face that has maximum correlation with the audio was chosen as the speaker. There were 14 wrong judgments yielding recognition rate of 56.2%. The LSI embodiment was then performed on each pair. Then the correlation was computed between audio and face features. In this LSI case, there were 8 false judgments yielding a recognition rate of 24/32=75%. There thus was a significant improvement compared to the results from the correlation embodiment without LSI.

The eigenface method discussed above was used to determine the effect of PCA (Principal Component Analysis). There are 7 persons in the video sets with 40 faces for each person. The first set of 10 faces of each person was used as a training set, and the remaining set of 30 faces was used as a test set. The first 16 eigenfaces are used to represent faces. A recognition rate of 100% was achieved. This result may be attributed to the fact that the video represents a very controlled environment. There is little variation in lighting and pose between the training set and test set. This experiment shows that PCA is a good face recognition method in some circumstances. The advantages are that it is easy to understand, and easy to implement, and it does not require too many computer sources.

In another embodiment, other sources of data can be used/combined to achieve enhanced person identification, for example, text (name-face association unit 60). A similar correlation process may be used to deal with the added feature (e.g., text).

In addition, face-speech matching process can be extended to video understanding, build an association between sound and objects that exhibit some kind of intrinsic motion while making that sound. In this regard the present invention is not limited to the person identification domain. The present invention also applies to the extraction of any intrinsic relationship between the audio and the visual signal within the video. For example, sound with an animated object can also be associated. The bark is associated with the dog barking, the chirp is associated with the birds, expanding yellow-red with an explosion sound, moving leafs and windy sound etc. Furthermore, supervised learning or clustering methods to build this kind of association may be used. The result is integrated knowledge about the video.

It is also noted that the LSI embodiment discussed above used the feature space from LSI. However, the frame space can also be used, e.g., the frame space can be used to perform frame clustering.

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

What is claimed is:

1. An audio-visual system for processing video data comprising:
an object detection module capable of providing a plurality of object features from the video data;
an audio processor module capable of providing a plurality of audio features from the video data;
a processor coupled to the object detection and the audio segmentation modules,
wherein the processor is arranged determine a correlation between the plurality of object features and the plurality of audio features.

2. The system of claim 1, wherein the processor is further arranged to determine whether an animated object in the video data is associated with audio.

3. The system of claim 2, wherein the plurality of audio features comprise two or more of the following average energy, pitch, zero crossing, bandwidth, band central, roll off, low ratio, spectral flux and 12 MFCC components.

4. The system of claim 2, wherein the animated object is a face and the processor is arranged to determine whether the face is speaking.

5. The system of claim 4, wherein the plurality of image features are eigenfaces that represent global features of the face.

6. The system of claim 1, further comprising a latent semantic indexing module coupled to the processor and that preprocesses the plurality of object features and the plurality of audio features before the correlation is performed.

7. The system of claim 6, wherein the latent semantic indexing module includes a singular value decomposition module.

8. A method for identifying a speaking person within video data, the method comprising the steps of:
receiving video data including image and audio information;
determining a plurality of face image features from one or more faces in the video data;
determining a plurality of audio features related to audio information;
calculating a correlation between the plurality of face image features and the audio features; and
determining the speaking person based upon the correlation.

9. The method according to claim 8, further comprising the step of normalizing the face image features and the audio features.

10. The method according to claim 9, further comprising the step of performing a singular value decomposition on the normalized face image features and the audio features.

11. The method according to claim 8, wherein the determining step includes determining the speaking person based upon the one or more faces that has the largest correlation.

12. The method according to claim 10, wherein the calculating step includes forming a matrix of the face image features and the audio features.

13. The method according to claim 12, further comprising the step of performing an optimal approximate fit using smaller matrices as compared to full rank matrices formed by the face image features and the audio features.

14. The method according to claim 13, wherein the rank of the smaller matrices is chosen to remove noise and unrelated information from the full rank matrices.

15. A memory medium including code for processing a video including images and audio, the code comprising:
code to obtain a plurality of object features from the video;
code to obtain a plurality of audio features from the video;
code to determine a correlation between the plurality of object features and the plurality of audio features; and
code to determine an association between one or more objects in the video and the audio.

16. The memory medium of claim 15, wherein the one or more objects comprises one or more faces.

17. The memory medium of claim 16, further comprising code to determine a speaking face.

18. The memory medium of claim 15, further comprising code create a matrix using the plurality of object features and the audio features and code to perform a singular value decomposition on the matrix.

19. The memory medium of claim 18, further comprising code to perform an optimal approximate fit using smaller matrices as compared to full rank matrices formed by the object features and the audio features.

20. The memory medium according to claim 19, wherein the rank of the smaller matrices is chosen to remove noise and unrelated information from the full rank matrices.
